(19) United States
(12) Patent Application Publication
(10) Pub. No.: US 2012/0173430 A1
(43) Pub. Date: Jul. 5, 2012

(54) PORTABLE PROMOTIONAL CONTENT AND INTERFACE APPARATUS

(75) Inventors: Giorgio Carnero, Frankfurt am Main (DE); Jay Denhart, Frankfurt am Main (DE); Michael Peters, Chicago, IL (US); Marco Randi, Steinbach/Taunus (DE)

(73) Assignee: LEO BURNETT COMPANY, INC., Chicago, IL (US)

(21) Appl. No.: 13/423,942

(22) Filed: Mar. 19, 2012

Related U.S. Application Data
(63) Continuation of application No. 12/936,862, filed on Nov. 30, 2010.
(60) Provisional application No. 61/043,879, filed on Apr. 10, 2008.
(60) Provisional application No. 61/078,060, filed on Jul. 3, 2008.

(51) Int. Cl. G06Q 30/02; G06F 21/22

(52) U.S. Cl. 705/51

(57) ABSTRACT

A portable promotional content and interface apparatus (200) comprises a housing (201) that houses a memory (203) and a control circuit (202). This memory comprises, at least in part, a hidden digital storage area (204). The memory stores encrypted digital end-user promotional content and the hidden digital storage area stores the corresponding encryption key(s). The control circuit operably couples to this memory and also to a computational-platform interface (206) (such as, but not limited to, a USB plug). So configured, the control circuit interfaces with an end user's computational platform (301) via this computational-platform interface. Via that connection, the control circuit then serves to confirm a pre-established right for the end user to experience the stored end-user promotional content and to use the encryption key(s) to facilitate the end user experiencing that digital end-user promotional content through the end-user computational platform upon confirming that pre-established right.

### RELATED APPLICATION(S)

This application claims the benefit of U.S. Provisional application No. 61/043,879, filed Apr. 10, 2008, and U.S. Provisional application No. 61/078,060, filed Jul. 3, 2008, which are both incorporated by reference in their entirety herein.

### TECHNICAL FIELD

This invention relates generally to the provision of promotional content to an end user.

### BACKGROUND

Promotional content of various kinds is known in the art. Generally speaking, as used here, “promotional content” refers to content that promotes a specific product or service and/or a source for such product/service in the mind of the content recipient in a manner intended to prompt a corresponding desire and/or a feeling of goodwill for that product/service/source. Such content can range, for example, from directly extolling reasons why the end user should immediately obtain the product/service to comprising content that is only intended to subtly build a consuming relationship with the end user over an extended period of time.

Web sites are a well-known mechanism to provide such promotional content to end users. Web sites can readily accommodate, for example, a wide variety of technical information, comparative information, pricing information, and related entertainment and attractions to interest an end user in visiting, and then re-visiting, such a site. The promotional content at such a site can comprise textual material, pictorial material, audio information, video information, and so forth and this wide range of presentation options also well suits the underlying provision of promotional content.

Unfortunately, and despite what appears to be a ubiquitous presence of web site-based promotional offerings, such a paradigm does not meet all marketing needs in these regards. There are many countries, municipalities, and other locations, for example, that lack Internet access having an adequate bandwidth to meaningfully realize these modem capabilities and offerings. There are also niche markets that, for one reason or another, are ill suited to web-based promotions. Some markets or promotional activities, for example, may require an initial end-user vetting process that a typical web-based approach cannot support with a sufficient degree of integrity. In some cases this may be the result of law or regulation while in other cases it may reflect the thinking and requirements of the sponsor of the promotional content.

### BRIEF DESCRIPTION OF THE DRAWINGS

The above needs are at least partially met through provision of the portable promotional content and interface apparatus described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a portable promotional content and interface apparatus comprises a housing that houses a memory and a control circuit. This memory comprises, at least in part, a hidden digital storage area. This memory stores encrypted digital end-user promotional content and also stores in the hidden digital storage area at least one corresponding encryption key. The control circuit operably couples to this memory and also to a computational-platform interface (such as, but not limited to, a USB plug). So configured, the control circuit interfaces with an end user's computational platform via this computational-platform interface. Via that connection, the control circuit then serves to confirm a pre-established right for the end user to experience the stored end-user promotional content and to use the one or more encryption keys tov. facilitate the end user experiencing that digital end-user promotional content through the end-user computational platform upon confirming that pre-established right.

By one approach, this portable promotional content and interface apparatus itself lacks a native capability to locally render the digital end-user promotional content perceivable to the end user. (As used herein, the expression “native” refers to functionality that is an inherent presently-enabled capability of the platform itself; to illustrate, one native capability of an ordinary pencil is the ability to leave an erasable visible mark on a surface such as paper. Also as used herein, the expression “render” refers to the actual perceivable presentation of visual, audible, olfactory, or haptic material and not merely to the sourcing or processing of signals that can ultimately be rendered perceivable in this manner.)

By one approach, the referred-to pre-established right for the end user to experience the digital end-user promotional content comprises a right that is established prior to providing the end user with physical possession of the portable promotional content and interface apparatus. This can comprise, as one simple example in these regards, establishing this right in a face-to-face exchange. During such an exchange, for example, the end user's identity and other qualifying credentials and standing can be ascertained and confirmed in a manner that prompts a high degree of confidence in the corresponding results.

So configured, such a portable promotional content and interface apparatus can be provided to previously-vetted end users to thereby ensure that only a correct and appropriate recipient will have access to the digital end-user promotional content stored in this apparatus. The architectural structure of the apparatus itself, in turn, will strongly contribute to denying access to this content to other individuals who may gain permanent or temporary possession of the apparatus. In particular, the use of hidden memory to store the encryption key (or keys) required to decrypt the digital end-user promotional content will frustrate both casual unauthorized persons and even so-called hackers.

In any event, now comfortable that the end user comprises a vetted and approved member of an intended audience, the digital end-user promotional content itself can constitute a literal mimicking of a typical web site. This can include a wide variety of multimedia content, interactive opportunities (including but not limited to contest and sweepstakes processing activities), relationship-building materials, and so forth. This, in turn, offers the possibility of providing an end user with the feel and performance of a generous bandwidth experience even in settings, or with platforms, that lack such a capability.

Those skilled in the art will recognize and appreciate that such a portable promotional content and interface apparatus can have any of a wide variety of form factors. It will further be appreciated that these teachings can be employed in a manner that leverages a wide variety of promotional content approaches and paradigms and that these teachings are highly scalable and will accommodate a wide variety of end users, computational platforms, promotional content, promotional paradigms, and so forth in a highly user-intuitive yet cost-effective manner.

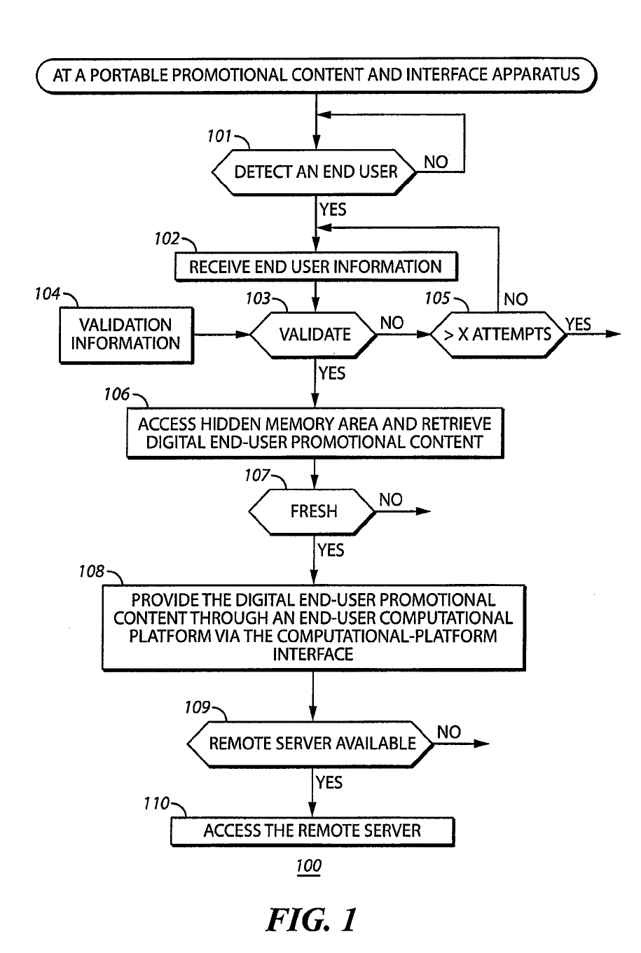

These and other benefits may become clearer upon making a thorough review and study of the following detailed description. Referring now to the drawings, and in particular to FIG. 1, an illustrative process 100 that is compatible with many of these teachings will now be presented. This illustrative process 100 is carried out by a corresponding portable promotional content and interface apparatus. (As used herein, the expression “portable” will be understood to refer to a platform that is easily and readily carried by or on the person of an average-sized adult human. Examples in these regards might include, but are not limited to, a laptop (or smaller) personal computer, a handheld cellular telephone or other two-way wireless communications device, and so forth.)

This process 100 includes the step 101 of detecting an end user (that is, an end user of the portable promotional content and interface apparatus itself where that end user may typically comprise part of a target audience for a given marketing effort). This step 101 of detecting the end user can be automated if desired. For example, a proximity detector of choice can serve in these regards to support such a capability. These teachings will also support, however, a more reactive approach. For example, the portable promotional content and interface platform can, upon being initially activated, automatically present a log-in display. Detection of the end user can then be based upon the end user responding to that log-in display by, for example, entering their identifying information using a keypad, voice recognition input, cursor control device, or the like.

Whether joined with this step 101 of detecting the end user or separated therefrom, this process 100 also provides the step 102 of receiving information from that end user. By one approach, this information can comprise, at least in part, identifying information for this end user. For many application settings this identifying information will comprise, at least in part, information that is particular to, and perhaps even completely unique to, this end user. Examples in these regards include, but are not limited to, a legal name for the end user, a user name for the end user, a password or Personal Identification Number (PIN) for the end user, or a biometric or biometric-based identifier (such as information relating to fingerprints, retinal patterns, keyboard-usage patterns, handwriting-based identification, speaker-based identification, and so forth).

This process 100 then provides the step 103 of validating the end user. This can comprise, for example, comparing one or more items of the received end user information with one or more comparable items of validation information 104 that is available a priori in this illustrative example to the portable promotional content and interface apparatus. As one simple example in these regards, this validation information may comprise a user name and a password that step 103 employs to test the validity of the corresponding information received from the end user in step 102.

Under some operating circumstances (when, for example, the portable promotional content and interface apparatus has access to remote resources as discussed below) it may be possible for the portable promotional content and interface apparatus to obtain this validation information, at a time of need, from a remote resource such as a corresponding server. As noted earlier, however, such connectivity may well be unavailable. Also, and again as noted above, this step of assuring the validated and vetted status of the end user may be sufficiently important that a remotely-based source for such information may be undesirable.

To accommodate such operational concerns, this validation information can be entered into and stored in the portable promotional content and interface apparatus at a time that precedes providing the end user with physical possession of the portable promotional content and interface apparatus. As but one simple illustrative example in this regard, a representative for the source/product/service being marketed can meet face-to-face with the end user. This representative can interview the end user during this meeting and request, inspect, copy, and otherwise process such information and/or evidentiary material as may be sufficient to establish the end user's credentials to satisfy the corresponding vetting requirements as pertain to this marketing effort.

Upon successfully completing this vetting activity, this representative can then enter the aforementioned validation information 104 into the portable promotional content and interface apparatus. Those skilled in the art will recognize that a variety of mechanisms and approaches are known in the art to accomplish such a result. By one approach, for example, an Electronically Erasable Programmable Read Only Memory (EEPROM) can serve to receive such information with the representative using a corresponding writer to place the necessary information therein.

It is of course possible that a legitimate and authorized end user may incorrectly identify themselves to the portable promotional content and interface apparatus. To accommodate such a circumstance, and upon failing to validate the end user at step 103, the portable promotional content and interface apparatus can permit the end user to retry the entry of their end-user information.

On the other hand, to frustrate an unauthorized person's attempt to gain access to the portable promotional content and interface apparatus by simply consecutively entering a great variety of test entries, this process 100 will optionally accommodate the step 105 of limiting the number of such retries to no more than X retries (where “X” will be understood to comprise some integer greater than 1 (where “1” assumes the trivial case where no such retries are permitted)). When X equals 3, for example, this process 100 will permit three such retries before taking some other action.

This other action will of course vary with the needs and/or opportunities as tend to characterize a given application setting and the capabilities of the portable promotional content and interface apparatus. By one simple approach, this other action can simply comprise effectively shutting down and accepting no further inputs from the end user. Such a state can persist until, for example, some predetermined period of time (such as a given number of minutes or hours) has passed or until some predetermined event has occurred (such as being reset by an authorized representative for the corresponding marketing effort).

Upon validating the end user at step 103, this process 100 then accesses the hidden area of the memory to retrieve the one or more encryption keys that are then used to decrypt the digital end-user promotional content in order to facilitate (at step 106) providing the end user with access to this digital end-user promotional content. This digital end-user promotional content can be stored in its entirety in a visible area of the memory or can be partially (or even wholly, if desired) stored in the hidden area of the memory.

By one approach, if desired, this process 100 can optionally serve to automatically prevent the end user from experiencing any of this digital end-user promotional content as a function of time. As one non-limiting example in these regards, this process 100 can include the step 107 of assessing the freshness of the digital end-user promotional content. By one approach, for example, portions or all of the digital end-user promotional content can be stored with a corresponding use-by date. When the present date is later than this use-by-date, this step 107 can comprise prohibiting the unfresh content from being experienced by the end user at this time. Such an approach may be useful when, for example, the digital end-user promotional content includes a contest that has now expired.

Other possibilities exist as well in these regards. For example, the process 100 can permit the end user to experience expired or non-fresh content but only while also providing a caution to the end user regarding the dated status of the content.

In any event, this process 100 then provides the step 108 of facilitating the accessed end user experiencing the digital end-user promotional content. As noted earlier, the portable promotional content and interface apparatus likely lacks a native ability to itself render such content perceivable to the end user. Therefore, this step 108 will typically comprise facilitating this experience through an end-user computational platform with which the portable promotional content and interface apparatus is cooperating. This end-user computational platform will itself have the requisite rendering functionality and capability. This end-user computational platform will also typically have an end-user interface to receive inputs (including instructions and responses) from the end user.

So configured, and as will be well understood by those skilled in the art, this step 108 of providing the digital end-user promotional content can essentially mimic an ordinary browser-based multimedia-styled website experience. This can include, for example, the provision of a home/splash page that provides information and links to other pages, documents, streaming content, and the like. As these resources are locally available on the portable promotional content and interface apparatus itself, however, this web-like experience can mimic the use of a high-bandwidth connection even in the absence of any connection whatsoever to a supporting network such as the Internet.

That said, it is possible that, at least from time to time and for at least some end users, the end user's computational platform may in fact have access to such a network. Such a connection may be wireless or non-wireless as will be well understood by those skilled in the art. Anticipating such an eventuality, this process 100 can also optionally accommodate the step 109 of determining the availability of one or more particular remote resources such as a remote server that corresponds to the aforementioned marketing effort. Upon detecting such a remote server, this process 100 can then effect the step 110 of accessing this remote server via the end user's computational platform.

The nature and substance of this interchange can of course vary with the needs and/or opportunities as tend to characterize a given application setting. By one approach, for example, this interchange can comprise validating a right of a given end user to experience the digital end-user promotional content. Such an approach can be useful, for example, when the end user has legitimately received the portable promotional content and interface apparatus following a face-to-face vetting meeting as was described above. By another approach, and again if desired, this interchange can comprise receiving from the remote server new digital end-user promotional content that can be employed at the present time or at some appropriate subsequent time. Those skilled in the art will recognize that numerous other possibilities exist in these same regards.

If desired, the portable promotional content and interface apparatus can access such a remote resource using standard networking message protocols such as HyperText Transfer Protocol (HTTP). This can go so far as to include, if desired, the use of intervening encryption by employing, for example, a Secure Sockets session when accessing the remote resource. In some cases, however, it may be preferred to seek an even higher degree of security. To meet such a need, these teachings will readily accommodate automatically interacting with the remote resource using Transport Control Protocol/Internet Protocol (TCP/IP) without also using HTTP. Instead, TCP/IC can encapsulate the substantive message content that itself is expressed using a non-standard protocol of choice. So configured, interception of a packet containing such content will not readily and easily result in trivial access to the substantive content of that packet.

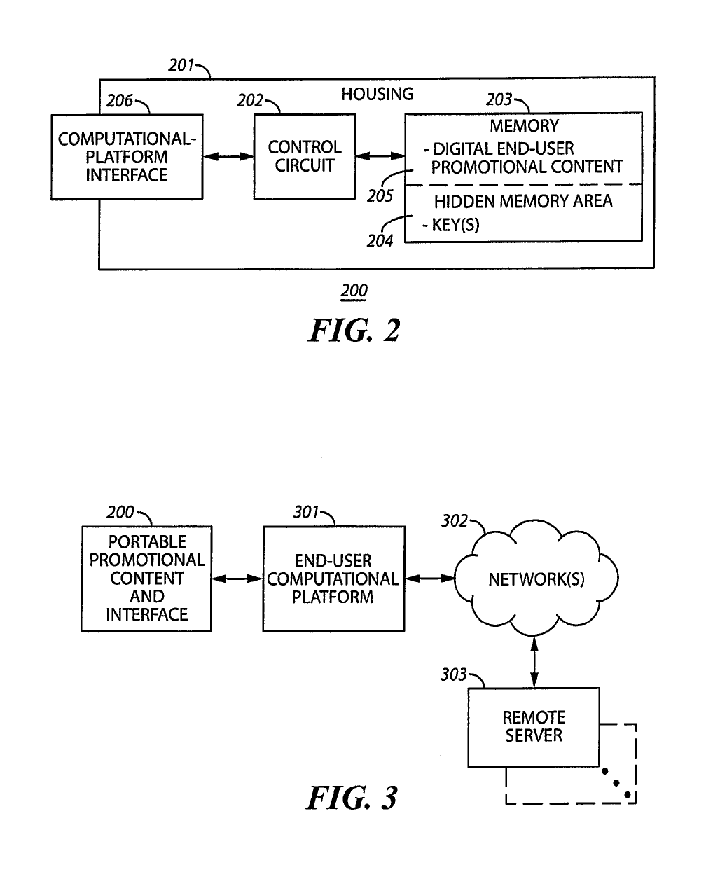

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example the portable promotional content and interface apparatus 200 comprises a housing 201 that houses a control circuit 202 and a memory 203. This housing 201 can be formed of any desirable material (such as a suitable hard plastic or metal) and can have any form factor as may tend to best suit the technical and/or aesthetic needs of a given application setting. Generally speaking, this housing 201 is likely to be relatively small such that it can be readily carried in a typical clothing pocket or purse and can be easily carried and manipulated by hand. For many application settings this form factor may comprise, or closely mimic, a Universal Serial Bus (USB) flash drive/dongle form factor as is known in the art.

The aforementioned memory 203 comprises, at least in part, a hidden digital storage area 204 in addition to any desired amount of visible digital storage area 205. As used herein, this reference to a “hidden” digital storage area will be understood to refer to an area of digital storage that is occluded from ordinary view when accessed by an external reader to thereby prevent ready access to any content that is stored in this area. Notwithstanding this property, of course, those skilled in the art will understand that such a hidden digital storage area can nevertheless be read and written to by, for example, the aforementioned control circuit 202 presuming that the latter has access to the requisite addressing and protocols information.

Suitable platforms that incorporate such a hidden digital storage area 204 are known in the art. Hagiwara Sys-Com, for example, manufactures and offers for sale such an apparatus. As these teachings are not overly sensitive to any particular selection in this regard, for the sake of brevity and the preservation of clarity, further elaboration in this regard will not be presented here.

As noted earlier, this memory 203 can comprise, if desired, a visible ordinarily-accessible area of memory 205. When so configured, any desired portion of the encrypted digital end-user promotional content can be stored in this visible area. By one approach, for example, all of the encrypted digital end-user promotional content can be stored in this visible area. The control circuit 202 is of course configured to decrypt the encrypted digital end-user promotional content using the corresponding keys that are stored in the hidden area 204 of the memory 203.

This portable promotional content and interface apparatus 200 also comprises a computational-platform interface 206 that operably couples to the control circuit 202. This computational-platform interface 206 serves to communicatively couple the control circuit 202 to a corresponding end-user computational platform such as a laptop computer or a cellphone. When this computational-platform interface 206 comprises a wireless interface (such as a Bluetooth-compatible wireless interface, to note but only one of a large number of possibilities in these regards) the computational-platform interface 206 can be fully encapsulated within the housing 201. When the computational-platform interface 206 comprises a non-wireless physical connector, at least a portion of the interface 206 will typically be at least physically accessible from the exterior of the housing 201.

By one approach, and by way of a non-limiting example, this computational-platform interface 206 can comprise a standard Universal Serial Bus (USB) plug (such as a male plug). Such USB plugs (and their corresponding standardized signaling protocols) are well known in the art and require no additional elaboration here. One benefit of using a USB-based approach, of course, is that the portable promotional content and interface apparatus 200 can rely upon the end user's computational platform as a source of operating power. Using this approach, the portable promotional content and interface apparatus 200 need not have an independent source of operating power.

The control circuit 202 can comprise a fixed-purpose hard-wired platform or can comprise a partially or wholly programmable platform. All of these architectural options are well known and understood in the art and require no further description here. So configured, this control circuit 202 can be configured (using, for example, corresponding programming or coding as will be well understood by those skilled in the art) to carry out one or more of the steps, actions, and functions described herein. This can comprise, for example, configuring the control circuit 202 to interface with an end user's computational platform via the computational-platform interface 206 in order to confirm a pre-established right for the end user to experience the digital end-user promotional content and to use the one or more encryption keys from the hidden area of the memory to facilitate the end user experiencing the digital end-user promotional content through the end-user computational platform via the computational-platform interface upon confirming this pre-established right.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

Referring now to FIG. 3, an illustrative example regarding the use of such a portable promotional content and interface apparatus 200 will be provided. In this example, a marketing representative for a particular product has met with a given end user and provided that end user with physical possession of such a portable promotional content and interface apparatus 200. Later, at a time and place convenient to the end user, this end user has coupled this portable promotional content and interface apparatus 200 to their own end-user computational platform 301 by use of a USB interface. In this illustrative example, this end-user computational platform comprises a laptop computer.

Upon establishing the corresponding USB-based connection, the portable promotional content and interface apparatus 200 operates through the laptop computer to present on the laptop computer's display a log-in window. This end user enters their identifying information and the portable promotional content and interface apparatus 200 validates their authorized status. The portable promotional content and interface apparatus 200 then presents the end user, via the laptop computer, with a browser-like experience to deliver the stored promotional content.

Although the foregoing will occur notwithstanding the lack of a network connection for the laptop computer, in this illustrative example the laptop computer in fact has a connection to one or more networks 302 (such as a local area wireless network, a cellular telephony wireless network, the Internet, and so forth). This, in turn, provides access to one or more remote servers 303. In this case, then, the portable promotional content and interface apparatus 200 can access the remote server 303 and download, for example, additional promotional content as may be useful or necessary to provide for the end user.

Those skilled in the art will recognize that such a portable promotional content and interface apparatus 200 comprises a highly flexible and easily-leveraged platform by which a wide variety of promotional content can be readily distributed and utilized by a particularly targeted demographic audience. More particularly, it will be appreciated that these teachings are well suited to the dissemination of promotional content that requires or benefits from highly selective distribution criteria. The typical modern end user, in turn, requires essentially no special training to successfully interact with the portable promotional content and interface apparatus 200. Instead, ubiquitous skills such as coupling a USB dongle to a laptop computer and interacting with a browser-like interface are largely technically sufficient to ensure a successful interaction with the portable promotional content and interface apparatus 200.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A portable promotional content and interface apparatus comprising:
a housing;
a computational-platform interface;
a memory disposed within the housing and comprising, at least in part, a hidden digital storage area;
encrypted digital end-user promotional content stored in the memory;
at least one encryption key stored in the hidden digital storage area of the memory;
a control circuit disposed within the housing and being operably coupled to the computational-platform interface and the memory and being configured to interface with an end user's computational platform via the computational-platform interface to:
confirm a pre-established right for the end user to experience the digital end-user promotional content;
use the at least one encryption key to facilitate the end user experiencing the digital end-user promotional content through the end-user computational platform via the computational-platform interface upon confirming the pre-established right.

2. The portable promotional content and interface apparatus of claim 1 wherein the computational-platform interface comprises a non-wireless interface.

3. The portable promotional content and interface apparatus of claim 1 wherein the non-wireless interface comprises a Universal Serial Bus (USB) plug.

4. The portable promotional content and interface apparatus of claim 1 wherein the pre-established right for the end user to experience the digital end-user promotional content comprises a right that is established prior to providing the end user with physical possession of the portable promotional content and interface apparatus.

5. The portable promotional content and interface apparatus of claim 1 wherein the portable promotional content and interface apparatus itself lacks a native ability to locally render the digital end-user promotional content perceivable to the end user.

6. The portable promotional content and interface apparatus of claim 1 wherein the control circuit is further configured to:
automatically interact with a remote server via the end user's computational-platform.

7. The portable promotional content and interface apparatus of claim 6 wherein the control circuit is configured to automatically interact with the remote server using Transport Control Protocol/Internet Protocol without using a HyperText Transfer Protocol (HTTP).

8. The portable promotional content and interface apparatus of claim 6 wherein the control circuit is configured to automatically interact with the remote server, at least in part, by at least one of:
validating a right of a given end user to experience the digital end-user promotional content;
receiving from the remote server new digital end-user promotional content.

9. The portable promotional content and interface apparatus of claim 1 wherein the control circuit is further configured to:
automatically prevent the end user from experiencing the digital end-user promotional content as a function of time.
